(19) United States
(12) Patent Application Publication
(10) Pub. No.: US 2018/0017051 A1
(43) Pub. Date: Jan. 18, 2018

(54) MANUAL PUMP

(71) Applicant: APTAR FRANCE SAS, Le Neubourg (FR)

(72) Inventors: Stephane BERANGER, Surtauville (FR); Frederic DUQUET, Crespieres (FR)

(73) Assignee: APTAR FRANCE SAS, Le Neubourg (FR)

(21) Appl. No.: 15/525,363

(22) PCT Filed: Nov. 13, 2015
(86) PCT No.: PCT/FR2015/053066

§ 371 Date: May 9, 2017

(30) Foreign Application Priority Data
Nov. 14, 2014 (FR) 1461018

(51) Int. Cl. F04B 49/24; B05B 11/00; F04B 23/02; F04B 9/14; F04B 53/16; F04B 53/10; F04B 53/14

(52) U.S. Cl. CPC F04B 49/24; F04B 23/028; B05B 11/3046; B05B 11/3067; B05B 11/3025; F04B 9/14; F04B 53/1087; F04B 53/14; F04B 53/16

(57) ABSTRACT

A manual pump (P) having a pump body (B) defining a slide cylinder (F) for a piston (K) secured to an actuator rod (S); a pump chamber (C) and an outlet valve (V) arranged between the pump chamber (C) and a dispenser orifice (O) so as to dispense the fluid from the pump chamber (C). The pump includes an inlet valve (2, 12) arranged between the pump chamber (C) and an inlet (I) of the pump (P) to take the fluid into the pump chamber (C) from the reservoir (R), the inlet valve having a movable member (2) that selectively bears against a valve seat (12), a return passage (23) enabling a fraction of the fluid that is put under pressure in the pump chamber (C) to escape therefrom without passing via the outlet valve (V). The return passage (23) creates a lack of sealing at the inlet valve.

The present invention relates to a manual pump for a fluid dispenser, the pump being for associating with a fluid reservoir, thereby forming a fluid dispenser. The pump comprises a pump body that defines a slide cylinder for a piston that is secured to an actuator rod, the pump further comprising a pump chamber in which a dose of fluid is put under pressure on each actuation. The pump further comprising an outlet valve that is arranged between the pump chamber and a dispenser orifice so as to dispense the fluid from the pump chamber, the pump further comprising an inlet valve that is arranged between the pump chamber and an inlet of the pump so as to take the fluid into the pump chamber from the reservoir, the inlet valve comprising a movable member that selectively bears against a valve seat. This is an entirely conventional design for a pump in the fields of perfumery, cosmetics, and pharmacy.

In general, the volume of the pump chamber is determined and unchanging for a particular pump model. In other words, in general it is not possible to modify the volume of the pump chamber. However, it is possible to adjust the volume of the pump chamber by acting on the top dead center corresponding to the rest position of the actuator rod and of the piston, as proposed in document FR 2 719 084, for example. In that document, provision is made to depress the hoop into the pump body to a greater or lesser extent, so as to adjust the volume of the pump chamber. This acts on the height of the stroke of the piston. Consequently, the pusher mounted on the pump is movable over a shorter height, which may disconcert the user who has the impression of not being able to depress the pusher fully.

Naturally, another solution for reducing the volume of the pump chamber is to make a completely new small-capacity pump. However, that involves considerable cost, given that the components of the miniature pump need to be designed and molded in specific manner.

An object of the present invention is to remedy the above-mentioned drawbacks of the prior art by defining a standard-capacity manual pump that is suitable for delivering a dose of fluid that is smaller than the volume of the pump chamber, without reducing the stroke of the piston and of the actuator rod, and without reducing the volume of the pump chamber. In other words, an object of the present invention is to dispense a dose of fluid that is incomplete relative to the capacity of the pump chamber.

To do this, the present invention proposes providing the pump with a return passage enabling a fraction of the fluid that is put under pressure in the pump chamber to escape therefrom without passing via the outlet valve. Thus, the entire dose of fluid stored in the pump chamber is not discharged through the outlet valve towards the dispenser orifice, since a fraction is diverted through the return passage, such that the fluid dispensed corresponds to an incomplete dose only from the pump.

When the pump of the invention is mounted on a fluid reservoir, it is advantageous for the return passage to communicate directly or indirectly with the fluid reservoir, so that the fluid that passes through the return passage is re-injected into the fluid reservoir. However, the fluid passing through the return passage could be stored, at least temporarily, in a buffer reservoir that may optionally communicate with the fluid reservoir.

In an embodiment of the invention, the return passage creates a lack of sealing at the inlet valve. In other words, the inlet valve leaks. By way of example, provision may be made for the return passage to be formed by the movable member. Advantageously, the return passage comprises at least one groove that is formed where the movable member comes into contact with its valve seat. In a variant or in addition, the return passage comprises a hole passing through the movable member that is advantageously in the shape of a disk. Provision may also be made for the return passage to be formed by the valve seat, in particular in the form of at least one slot. The return passage may thus be formed by the movable member and/or its valve seat.

According to another advantageous characteristic of the invention, an additional return passage may be formed by the pump body. Advantageously, the additional return passage comprises a direct borehole that passes through the wall thickness of the pump body and connects the pump chamber directly to the reservoir. In this configuration, the inlet valve may be of an entirely conventional type. In another embodiment, the pump body includes a dip tube that is connected to the inlet of the pump, the additional return passage comprising a bypass that connects the pump chamber to the dip tube without passing via the inlet valve. In this configuration, the bypass makes it possible to shunt the inlet valve. Preferably, the pump includes an outer sheath that surrounds the pump body, the bypass extending, in part, between the pump body and the outer sheath and advantageously comprising at least one inner borehole that passes through the wall thickness of the pump body.

In another embodiment of the invention, the additional return passage may be formed in the slide cylinder.

The invention also defines a fluid dispenser comprising a fluid reservoir on which there is mounted a manual pump as defined above, the return passage, and possibly the additional return passage, enabling a fraction of the fluid that is put under pressure in the pump chamber to be returned directly or indirectly to the fluid reservoir.

The spirit of the invention resides in providing a kind of leak from the pump chamber, so that the entire dose stored in the pump chamber is not discharged through the outlet valve and the dispenser orifice, a greater or lesser fraction of the dose being redirected to another outlet that preferably communicates with the fluid reservoir. The leak may be made in the inlet valve, and/or directly in the wall of the pump chamber that communicates directly with the fluid reservoir, and/or so as to shunt the inlet valve by connecting the pump chamber directly to the dip tube. By accurately determining the section and the length of the return passage, it is possible to adjust the volume of the partial dose discharged through the outlet valve and the dispenser orifice with accuracy. Provision may be made for only one return passage or for a plurality, optionally combined with one or more additional return passages as a function of the design of the pump and of the looked-for results.

In certain embodiments, it should be observed that the additional return passages may be used independently of the return passages in the inlet valve. Separate protection could be sought for the additional return passages.

The invention is described more fully below with reference to the accompanying drawings which show several embodiments of the invention by way of non-limiting example.

In the figures:

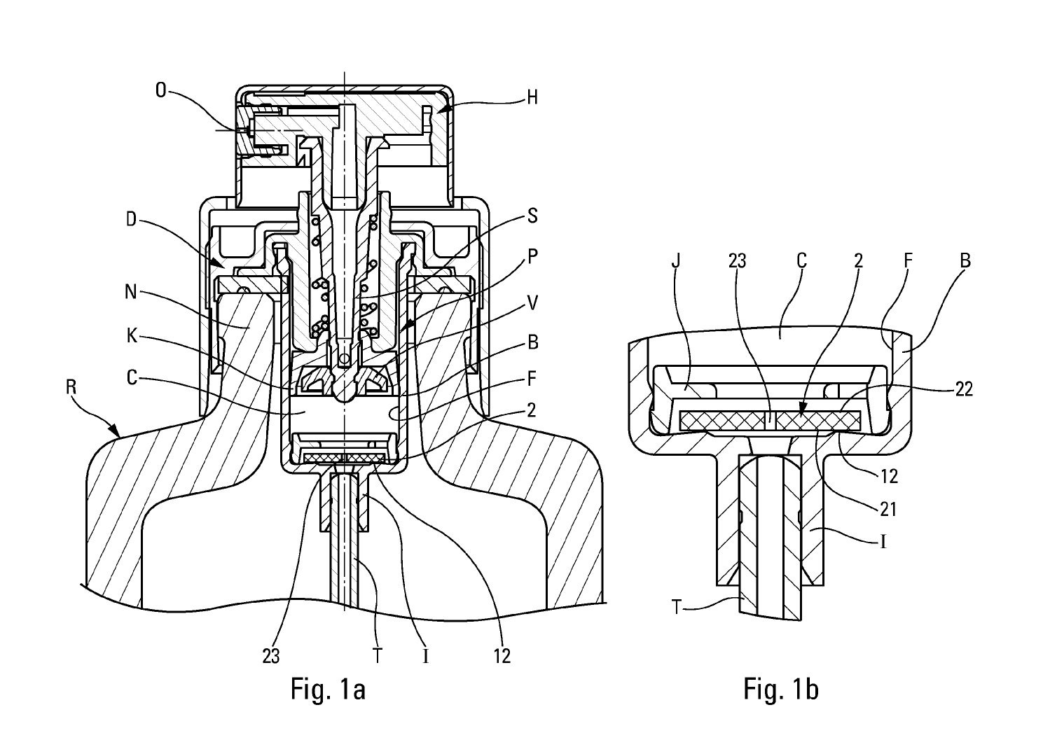

FIG. 1a is a vertical-section view through a fluid dispenser incorporating a pump in a first embodiment of the invention;

FIG. 1b is a larger-scale view of the bottom portion of the FIG. 1a pump;

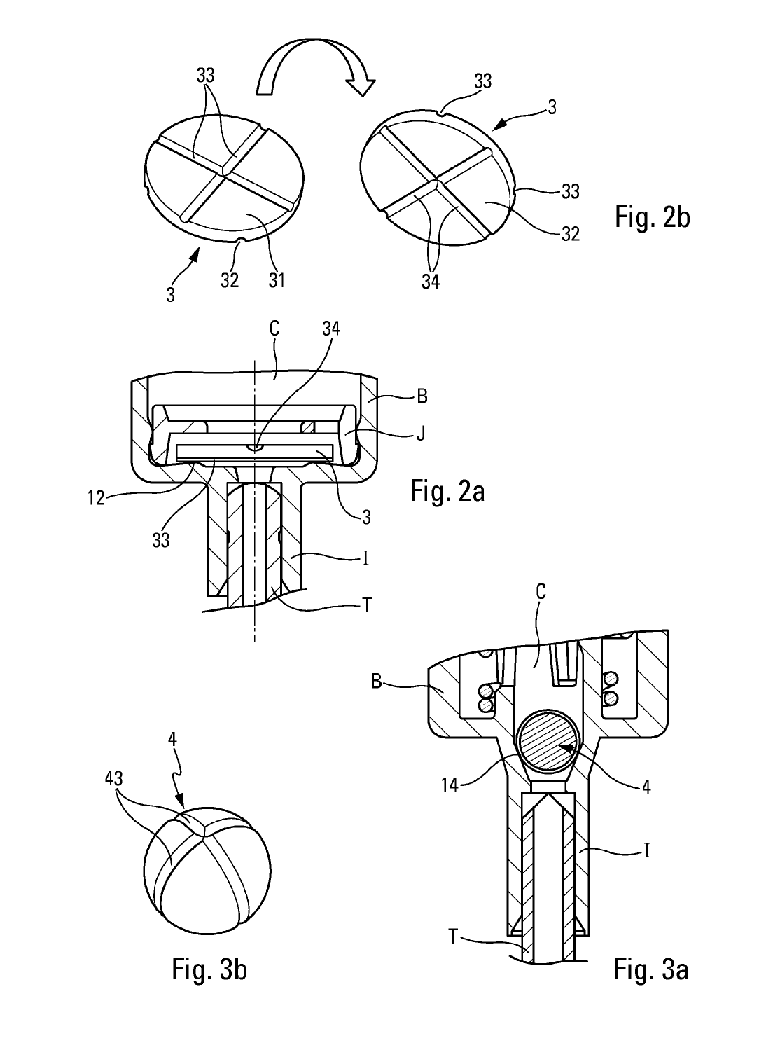

FIG. 2a is a view similar to the view in FIG. 1b, showing a second embodiment of the invention;

FIG. 2b is a perspective view of the movable member used in the FIG. 2a pump;

FIG. 3a is a large-scale vertical section view of the bottom portion of a pump in a third embodiment of the invention;

FIG. 3b is a large-scale perspective view of the movable member of the FIG. 3a pump;

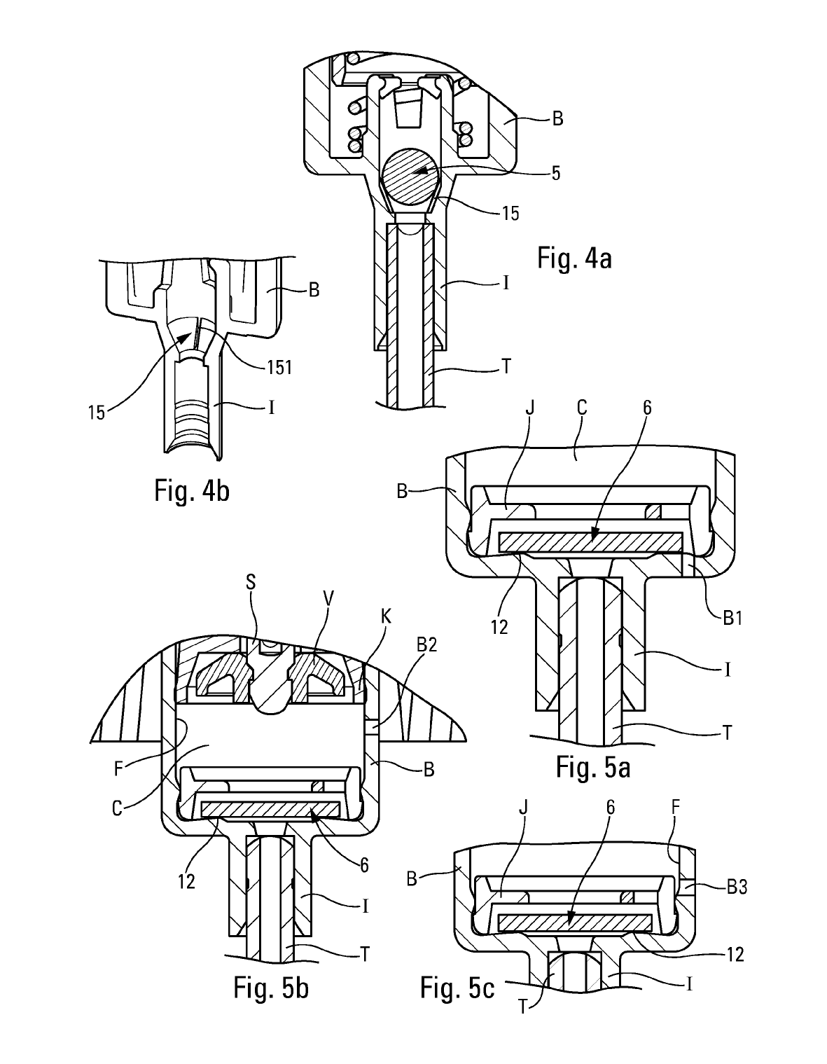

FIG. 4a is a view similar to the view in FIG. 3a for a fourth embodiment of the invention.

FIG. 4b is a cut-away perspective view showing the valve seat of the FIG. 4a pump;

FIG. 5a is a view similar to FIG. 2a for a fifth embodiment of a pump of the invention;

FIG. 5b is a view similar to FIG. 2a for a sixth embodiment of a pump of the invention;

FIG. 5c is a view similar to FIG. 2a for a seventh embodiment of a pump of the invention;

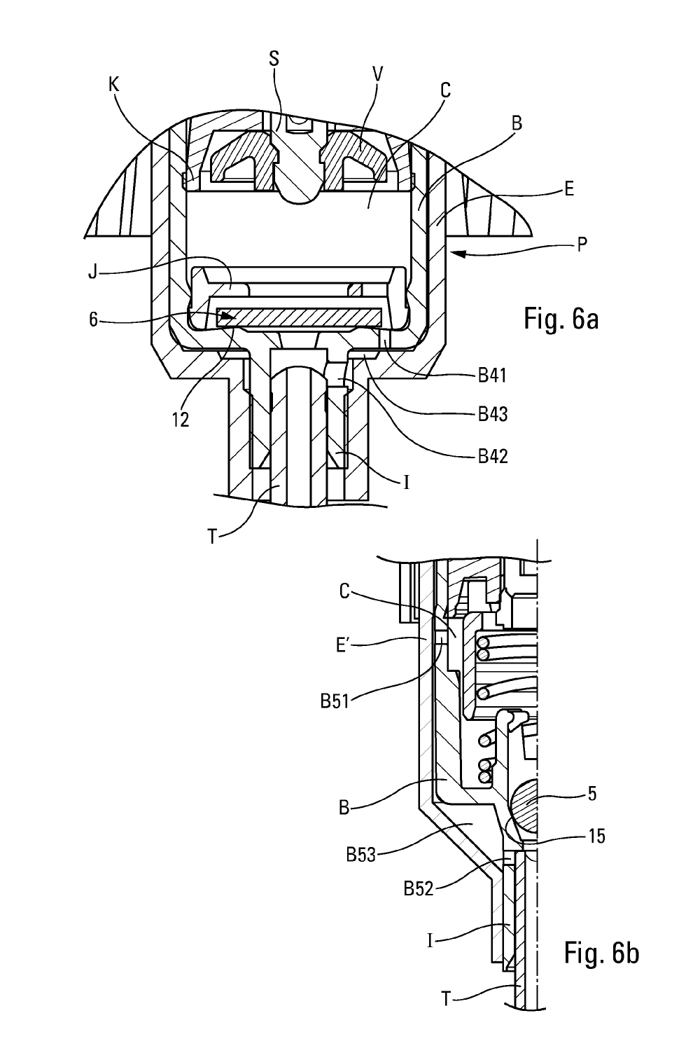

FIG. 6a is a large-scale view of the bottom portion of a pump in an eighth embodiment of the invention; and

FIG. 6b is a vertical section view of a pump in a ninth embodiment of the invention.

Reference is made firstly to FIGS. 1a and 1b in order to describe in detail a complete dispenser incorporating a manual pump P in the first embodiment.

The fluid dispenser includes a fluid reservoir R for containing a fluid, e.g. that may be a fragrance, an eau de toilette, a lotion, a cream, a gel, a pharmaceutical, etc. The fluid reservoir R may be made of any appropriate material and may present any configuration, given that the reservoir itself is not critical to the present invention. By way of example, the reservoir R may be provided with a neck N that defines a constricted opening in which the manual pump P is housed.

In entirely conventional manner, the pump P includes a pump body B that defines a fluid inlet I that may be provided with a dip tube T that extends in the reservoir R into the proximity of, or into contact with, its bottom. The body B also defines a slide cylinder F that has a shape that is cylindrical, preferably circular. Upstream from its inlet I, the body B is also provided with an inlet valve that includes a movable member 2 for selectively coming into leaktight contact with a valve seat 12. This inlet valve is described more fully below. The pump P also includes an actuator rod S that is covered by a pusher H that defines a dispenser orifice O. The actuator rod S serves as a support to the piston K and to an outlet valve V. The piston K is mounted to slide in leaktight manner inside the slide cylinder F of the pump body B. The pump P thus defines a pump chamber C for filling with fluid from the reservoir R, through the dip tube T and the inlet valve. When the pump chamber C is full of fluid, the user can press on the pusher H so as to press the actuator rod S into the pump body D. The piston K is mounted to slide over the actuator rod S against a pre-compression spring, so that the outlet valve V opens as soon as the pressure inside the pump chamber C has reached a predetermined threshold. More precisely, at rest, the piston K bears against the outlet valve V in leaktight manner. When the piston K slides over the actuator rod S, it lifts off the outlet valve V, thereby opening an outlet passage for the fluid under pressure that is discharged through the actuator rod S until it reaches the dispenser orifice O where it is dispensed optionally as a spray. When the user relaxes the pressure on the pusher H, the actuator rod S returns to its rest position under the action of a return spring. The volume of the pump chamber C is thus once again in its maximum state. This design is entirely conventional for a pump in the fields of perfumery, cosmetics, and pharmacy. Without going beyond the ambit of the invention, the design of the outlet valve could be different, given that the outlet valve is not critical to the present invention. It is even possible to envisage that the manual pump does not have an outlet valve: for example, it is possible to envisage a pusher H fitted with a built-in shutter that acts as an outlet valve.

With reference to FIG. 1b, it can be seen more clearly that the inlet valve includes a movable member 2 that is in the form of a disk, an O-ring, or a washer that bears in leaktight manner against a valve seat 12. Advantageously, the disk presents an annular shape with a bottom face 21 and a top face 22 that extend in substantially parallel manner. By way of example, the peripheral edge of the movable member 2 may be circularly cylindrical. It can be seen that the bottom face 21 is in contact with the valve seat 12, which may be in the form of a bead or an annular rib, for example. In order to limit the movement of the movable member 2, a stroke limiter J is provided that is fastened inside the pump body B. The stroke limiter J nevertheless allows fluid to pass. When the pump is at rest, the movable member 2 bears merely by gravity against its seat 12. When the pump chamber C is under pressure, the movable member 2 is pressed against its seat 12 in completely leaktight manner. This design is entirely conventional for a valve that uses a movable member in the form of a disk, a washer, or an O-ring.

In the invention, the movable member 2 is formed with a through hole 23 that connects the bottom face 21 to the top face 22. The through hole 23 presents a flow section that is small compared to the diameter of the slide cylinder F, and even to the inside diameter of the dip tube T. By way of example, the flow section of the through hole 23 may be about 0.1 square millimeters (mm²). FIG. 1b shows only a single through hole 23, but a plurality of through holes could be provided, without going beyond the ambit of the invention.

Thus, when the user depresses the pusher H and thus puts the fluid stored in the pump chamber C under pressure, the outlet valve V opens so as to allow a fraction of the fluid to pass from the pump chamber, but another fraction of the fluid from the pump chamber is returned into the dip tube T through the through hole 23 of the movable member 2. By acting on the flow section of the through hole 23, the proportions of fluid discharged through the actuator rod S and through the through hole 23 can be adjusted.

With a single hole through the disk constituting the movable member 2, the volume of fluid dispensed through the dispenser orifice O can be reduced, without greatly modifying the manual pump P. Specifically, it is extremely easy to make the through hole 23. The through hole 23 forms a return passage that enables a fraction of the fluid stored and put under pressure in the pump chamber C to be returned to the reservoir R through the fluid inlet I and the dip tube T.

FIGS. 2a and 2b show a second embodiment of the invention in which the movable member 3 is also in the form of a disk, an O-ring, or a washer that is not however pierced, but grooved. Specifically, in FIG. 2b, it can be seen that the two faces 31 and 32 are provided with grooves 33 and 34, in this embodiment in the shape of a cross. It may even be observed that the crosses formed by the grooves are offset from one face to the other, so as to avoid weakening the disk. In FIG. 2a, it can be seen that the disk bears against its seat 12 in leaktight manner, except where the grooves 33 extend over the valve seat 12. Thus, the grooves 33 or 34 create a lack of sealing in the inlet valve. As in the first embodiment, the grooves 33, 34 constitute a return passage enabling a fraction of the fluid stored and put under pressure in the pump chamber C to be returned to the reservoir through the inlet I and the dip tube T.

The through hole 23 and the grooves 33, 34 could be made in the same movable member. One or more grooves could also be formed in the valve seat 12.

FIGS. 3a and 3b show a third embodiment of the invention that uses a movable member 4 in the form of a ball provided with grooves 43. Thus, when the ball bears against its valve seat 14, the grooves 43 create a lack of sealing in the inlet valve, as with the grooves 33 or 34 of the above embodiment. Once more, the grooves 43 constitute a return passage enabling a fraction of the fluid stored and put under pressure in the pump chamber C to be returned to the fluid reservoir.

FIGS. 4 and 4b show a fourth embodiment of the invention in which the movable member 5 is a completely spherical conventional ball that bears against a frustoconical valve seat 15 that is provided with at least one slot 151 that creates a lack of sealing, and thus constitutes a return passage for a fraction of the fluid stored and put under pressure in the pump chamber C.

FIGS. 5a, 5b, 5c, 6a, and 6b show embodiments in which return passages are provided that can be referred to as “additional” in the sense that they may be used together with the return passages in FIGS. 1a, 1b, 2a, 2b, 3a, 3b, 4a, 4b formed at the inlet valve.

FIG. 5a shows a fifth embodiment of the invention in which the pump body B is pierced with a direct borehole B1 that puts the pump chamber C into direct communication with the inside of the reservoir R. In this embodiment, the direct borehole B1 is situated in the direct proximity of the movable member 6 of the inlet valve that is in the form of a conventional disk.

In FIG. 5b, the pump body B is also pierced with a direct borehole B2 that is formed in the slide cylinder F. In other words, when the actuator rod S is fully depressed, the piston K passes over the direct borehole B2 and isolates it from the pump chamber C.

In FIG. 5c, the direct borehole B3 is formed in the bottom end of the slide cylinder F level with the stroke limiter J.

In these last three embodiments of FIGS. 5a, 5b, and 5c, each of the direct boreholes B1, B2, and B3 constitutes a return passage that puts the pump chamber C into direct communication with the fluid reservoir R.

In FIG. 6a, the pump body B is surrounded by an outer sheath E that even surrounds the fluid inlet I, advantageously in leaktight manner. The fluid stored and put under pressure in the pump chamber C can escape therefrom in order to return into the dip tube T through a bypass that comprises a first inner borehole B41 that is formed in the proximity of the movable member 6 of the inlet valve, an annular space B43 that is formed between the pump body B and the sheath E, and another inner borehole B42 that is formed in the fluid inlet I and that communicates directly with the outlet of the dip tube T. This return passage thus makes it possible to go around, or to shunt, the inlet valve by connecting the pump chamber C directly to the dip tube T.

FIG. 6b shows a variant embodiment of FIG. 6a that also uses an outer sheath E′ that surrounds the pump body B. The pump body is pierced with a first inner borehole B51 and with a second inner borehole B52 at the inlet I. The two inner boreholes are interconnected by an intermediate gap B53 such that the pump chamber C is connected directly to the dip tube T by going around, or shunting, the inlet valve formed by a ball 5 bearing against the frustoconical valve 15.

The above-described embodiments show that it is possible to divert a fraction of fluid stored and put under pressure in the pump chamber, in order to redirect it to the fluid reservoir through a leaky inlet valve, or additionally through the wall of the pump chamber, or through a bypass that goes around, or shunts, the inlet valve and that leads to the dip tube.

By means of the invention, it is possible to reduce the quantity of fluid dispensed from a pump chamber of considerably greater volume. In the field of perfumery for example, the doses of fluid dispensed each time the pump is actuated generally lie in the range about 50 microliters (mL) to 150 mL. For a pump that normally dispenses 100 mL doses, the present invention makes it possible to reduce the volume of fluid dispensed to about 50 mL, or even to about 10 mL, i.e. a reduction lying in the range about 50% to 90%, while naturally preserving the total stroke of the pump. The return passage, which may be in the form of one or more channels, holes, grooves, slots, bypasses, etc., may present a single or combined section lying in the range about 0.03 mm² (0.1 millimeter (mm) in diameter) to 0.5 mm² (0.8 mm in diameter), with a preferred section of about 0.1 mm².

1. A manual pump for a fluid dispenser, the pump being for associating with a fluid reservoir, thereby forming a fluid dispenser, the pump comprising a pump body that defines a slide cylinder for a piston that is secured to an actuator rod, the pump further comprising a pump chamber in which a dose of fluid is put under pressure on each actuation, the pump further comprising an outlet valve that is arranged between the pump chamber and a dispenser orifice so as to dispense the fluid from the pump chamber, the pump further comprising an inlet valve that is arranged between the pump chamber and an inlet of the pump so as to take the fluid into the pump chamber from the reservoir, the inlet valve comprising a movable member that selectively bears against a valve seat, a return passage enabling a fraction of the fluid that is put under pressure in the pump chamber to escape therefrom without passing via the outlet valve; the return passage creating a lack of sealing at the inlet valve;
the manual pump being characterized in that the return passage is formed by the inlet valve, such that the inlet valve is thus leaky.

2. A manual pump according to claim 1, wherein the return passage is formed by the movable member.

3. A manual pump according to claim 1, wherein the return passage comprises at least one groove that is formed where the movable member comes into contact with its valve seat.

4. A manual pump according to claim 1, wherein the return passage comprises a hole passing through the movable member that is advantageously in the shape of a disk.

5. A manual pump according to claim 1, wherein the return passage is formed by the valve seat, in particular in the form of at least one slot.

6. A manual pump according to claim 1, wherein an additional return passage is formed by the pump body.

7. A manual pump according to claim 6, wherein the additional return passage comprises a direct borehole that passes through the wall thickness of the pump body and connects the pump chamber directly to the reservoir.

8. A manual pump according to claim 6, wherein the pump body includes a dip tube that is connected to the inlet of the pump, the additional return passage comprising a bypass that connects the pump chamber to the dip tube without passing via the inlet valve.

9. A manual pump according to claim 8, wherein the pump includes an outer sheath that surrounds the pump body, the bypass extending, in part, between the pump body and the outer sheath and advantageously comprising at least one inner borehole that passes through the wall thickness of the pump body.

10. A manual pump according to claim 6, wherein the additional return passage is formed in the slide cylinder.

11. A manual pump according to claim 1, wherein about 50% to 90% of the dose of fluid that is put under pressure in the pump chamber (C) escapes through the return passage (23; 33, 34; 43; 151).

12. A manual pump according to claim 6, wherein about 50% to 90% of the dose of fluid that is put under pressure in the pump chamber escapes through the return passage, and possibly through the additional return passage.

13. A manual pump according to claim 1, wherein the return passage presents a single or combined section lying in the range about 0.03 mm² to 0.5 mm², with a preferred section of about 0.1 mm².

14. A manual pump according to claim 6, wherein the return passage, and possibly the additional return passage, present(s) a single or combined section lying in the range about 0.03 mm² to 0.5 mm², with a preferred section of about 0.1 mm².

15. A fluid dispenser comprising a fluid reservoir on which there is mounted a manual pump according to claim 1, the return passage enabling a fraction of the fluid that is put under pressure in the pump chamber to be returned directly or indirectly to the fluid reservoir.
